(19) United States
(12) Patent Application Publication
(10) Pub. No.: US 2023/0049155 A1
(43) Pub. Date: Feb. 16, 2023

(54) Gravity and Inertial Compensation of Force/Torque Sensors

(71) Applicant: ATI Industrial Automation, Inc., Apex, NC (US)

(72) Inventor: Samuel Koenke, Cary, NC (US)

(21) Appl. No.: 17/400,181

(22) Filed: Aug. 12, 2021

(51) Int. Cl. B25J 13/08

(52) U.S. Cl. CPC B25J 13/085; B25J 13/088

(57) ABSTRACT

Force and torque measurements from a robotic F/T sensor are compensated for the effects of gravity, and optionally additionally for the effects of robot motion. The weight of an attached tool Wₜₒₒₗ, and a vector \vec{r}_{CG} from the F/T sensor body CF origin to a center of gravity of the tool are obtained, such as from user input or by parameter identification. During a robotic operation, a rotation matrix R_{International CF}^{Body CF} from the F/T sensor body CF to an inertial reference frame is obtained, such as from an internal inertial measurement unit (IMU), or from forward kinematics data from the robot. The force and torque measurements resolved by the F/T sensor from transducer outputs are compensated for gravity based on the Wₜₒₒₗ and \vec{r}_{CG}, and the instantaneous value of R_{International CF}^{Body CF}. For inertial compensation, the additional information is obtained, including: the mass m of the attached tool; the angular velocity \vec{ω} of the F/T sensor body CF; the angular acceleration \dot{ω} of the F/T sensor body CF; the linear acceleration \vec{a} of the F/T sensor body CF; and inertia tensor I defined in the F/T sensor body CF which contains all moments and products of inertia. The force and torque measurements resolved by the F/T sensor from transducer outputs are compensated for inertial effects based on m, \vec{ω}, \vec{ω}, \vec{r}_{CG}, \vec{α}, and I.

### FIELD OF INVENTION

The present invention relates generally to robotics, and in particular to compensation of robotic force/torque sensors for gravitational and inertial forces.

### BACKGROUND

Robots are an indispensable part of manufacturing, testing, assembly, and packing of products; assistive and remote surgery; space exploration; operation in hazardous environments; and many other applications. Many robots and robotic applications require quantization of forces applied or experienced, such as material removal (grinding, sanding, and the like), remote digging or other manipulation of the environment, and the like.

As a representative example, consider a robot performing some task on a workpiece. The robot typically comprises a generic actuator, or “arm,” that is programmed to move through space and operate on a workpiece along numerous degrees of freedom. A robotic tool changer is an electromechanical device that allows the robot to perform many different tasks, using many different tools (also known as end effectors). The robotic tool changer comprises a “master” assembly attached to the robotic arm, and a plurality of similar or identical “tool” assemblies, each attached to a tool the robot may use. The master and tool assemblies are selectively coupled together under the control of a robotic control system. The master and tool assemblies may additionally include features for passing utilities—such as AC or DC electrical current, pneumatic fluid, data, or the like between them, for use by the tool, and provide a path for the tool to relay data back to the control system. With a tool changer, a robot may perform a task using first tool, park the first tool in a tool stand, retrieve a second tool, and perform another task using the second tool.

In applications where the degree of force the robot is to apply to a workpiece must be monitored and controlled, and/or the force the robot experiences is fed back to control the robot's motion (a “force control” operation), a force/torque (F/T) sensor is attached between the robot arm and master assembly of the tool changer, or between the tool assembly and a tool (or the F/T sensor functionality may be built into the tool changer). As depicted in FIG. 3, one configuration of an F/T sensor 12 comprises one member, called a Mounting Adapter Plate (MAP) 14 which is (directly or indirectly) mounted to the robot, and another member, called a Tool Adapter Plate (TAP) 16 to which a tool is (directly or indirectly) attached. The MAP 14 and TAP 16 are connected to each other by a plurality of relatively thin (and hence mechanically deformable) beams 18. Relative force or torque between the robot and tool respectively attached to the MAP 14 and TAP 16 attempt to move the MAP 14 relative to the TAP 16, resulting in slight deformation, or bending, of at least some of the beams 18. Strain gages (not shown) attached to the surface(s) of the beams 18 detect this deformation, and output proportional electrical signals. The outputs of numerous such sensors may be jointly processed to resolve the forces and torques applied to the F/T sensor 12, along defined axes. One example of a compact F/T sensor is described in U.S. Pat. No. 10,422,707, assigned to the assignee of the present disclosure and incorporated herein by reference in its entirety. Note that the configuration depicted in FIG. 3, wherein the TAP 16 is disposed annularly around the MAP 14, and the beams 18 are arranged like spokes on a wheel, is representative only and is not limiting. Numerous configurations of F/T sensors are known in the art.

Thermal drift is one known source of error in resolving forces and torques from F/T sensor outputs. One example of temperature compensation for a robotic F/T sensor is described in international patent publication WO 2018/200668, assigned to the assignee of the present disclosure and incorporated herein by reference in its entirety.

For static orientation basis functions, thermal compensation is sufficient to achieve accurate force and torque monitoring. The robot moves the tool to a working position and orientation, and the sensor data are zeroed. So long as the robot maintains the same orientation, and at moves at speeds low enough that inertial effects are negligible, the F/T sensor provides accurate readings of forces and torques, as the robotic tool accomplishes its task. However, tasks such as contour following, 3D parts assembly, and the like, require changes in the robotic tool orientation and/or position. Orientation changes alter the distribution of the weight of the tool along the axes of the F/T sensor reference frame, and position changes impart inertial forces and/or torques from the robot movement. Both phenomena deleteriously impact force and torque measurement accuracy. Indeed, in many cases gravitational and inertial forces and torques exceed desired contact forces and torques, making force control robotic operations difficult or impossible.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section. FIG. 3 is referenced here to provide an introduction to one configuration of parts in an F/T sensor; however, FIG. 3 does not depict prior art.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, force and torque measurements from a robotic F/T sensor are compensated for the effects of gravity, and optionally additionally for the effects of robot motion. The weight of an attached tool Wₜₒₒₗ and a vector \vec{r}_{CG} from an F/T sensor body Coordinate Frame (CF) origin to a center of gravity of the tool are obtained, such as from user input or by parameter identification. During a robotic operation, a rotation matrix R_{International CF}^{Body CF} from the F/T sensor body CF to an inertial reference frame is obtained, such as from an internal inertial measurement unit (IMU), or from forward kinematics data from the robot. The force and torque measurements resolved by the F/T sensor from transducer outputs are compensated for gravity based on the Wₜₒₒₗ and \vec{r}_{CG}, and the instantaneous value of R_{International CF}^{Body CF}. For inertial compensation, additional information is obtained, including: the mass m of the attached tool; the angular velocity \vec{ω} of the F/T sensor body CF; the angular acceleration \dot{ω} of the F/T sensor body CF; the linear acceleration a of the F/T sensor body CF; and inertia tensor I defined in the F/T sensor body CF which contains all moments and products of inertia. The mass m may be derived from W₀₀, and \vec{ω} and \dot{ω} may be obtained from the IMU or forward kinematics. The linear acceleration \vec{α}, is obtained by first estimating the gravitational acceleration from absolute orientation data and transforming that into an estimated gravity vector. This estimated gravity vector is then subtracted from the acceleration vector obtained from the IMU or forward kinematics data. The terms of I may be obtained from parameter identification, or input by a user if they are known from analytical determination or CAD software. The force and torque measurements resolved by the F/T sensor from transducer outputs are compensated for inertial effects based on m, \vec{ω}, \dot{ω}, \vec{r}_{CG}, \vec{α}, and I

One embodiment relates to a robotic force/torque (F/T) sensor including transducers configured to generate signals in response to forces or torques applied to the sensor. The F/T sensor includes measurement circuitry configured to resolve force and torque measurements from the transducer signals, the force and torque measurements referenced to a body Coordinate Frame (CF) of the F/T sensor. The F/T sensor additionally includes compensation circuitry. The compensation circuitry is configured to obtain the weight Wₜₒₒₗ of an attached tool; obtain a vector \vec{r}_{CG} from the F/T sensor body CF origin to a center of gravity of the tool; obtain a rotation matrix R_{International CF}^{Body CF} from the F/T sensor body CF to an inertial reference frame; and compensate the force and torque measurements for gravitational effects of the attached tool based on R_{International CF}^{Body CF}, Wₜₒₒₗ, and \vec{r}_{CG}.

Another embodiment relates to a method of compensating force and torque measurements resolved from transducer output signals of a robotic Force/Torque (F/T) sensor by measurement circuitry for gravitational effects due to the weight of an attached tool. The force and torque measurements are referenced to a body Coordinate Frame (CF) of the F/T sensor. The F/T sensor includes compensation circuitry. The weight Wₜₒₒₗ of a tool attached to the F/T sensor is obtained. A vector \vec{r}_{CG} from the F/T sensor body CF origin to a center of gravity of the tool is obtained. A rotation matrix R_{Inertial CF}^{Body CF} from the F/T sensor body CF to an inertial reference frame is obtained. The force and torque measurements are compensated for gravitational effects of the attached tool based on R_{International CF}^{Body CF}, Wₜₒₒₗ, and \vec{r}_{CG}.

Yet another embodiment relates to a robotic force/torque (F/T) sensor including transducers configured to generate signals in response to forces or torques applied to the sensor. The F/T sensor includes measurement circuitry configured to resolve force and torque measurements from the transducer signals, the force and torque measurements referenced to a body Coordinate Frame (CF) of the F/T sensor. The F/T sensor includes compensation circuitry configured to obtain a mass m of the attached tool; obtain an angular velocity \vec{ω} of the F/T sensor body CF; obtain an angular acceleration \dot{ω} of the F/T sensor body CF; obtain a linear acceleration \vec{α} of the F/T sensor body CF; obtain the inertia tensor I defined in the F/T sensor body CF which contains all moments and products of inertia; and compensate the force and torque measurements for inertial effects of movement of the robot based on m, \vec{ω}, \dot{ω}, \vec{r}_{CG}, \vec{α}, and I.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a diagram of a robot arm with a F/T sensor and tool attached.

FIG. 2 is a block diagram of an F/T sensor and tool attached, with centers of gravity and a body coordinate frame identified.

FIG. 3 is a perspective section exploded diagram view of an F/T sensor with an IMU.

FIG. 4 is a diagram of a system including an external electronics module using robotic forward data to obtain parameters for compensation.

FIG. 5 is a flow diagram of a method of compensating force and torque measurements resolved from transducer output signals of a F/T sensor for gravitational effects due to the weight of an attached tool.

FIG. 6 is a graph of raw and compensated F/T data.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

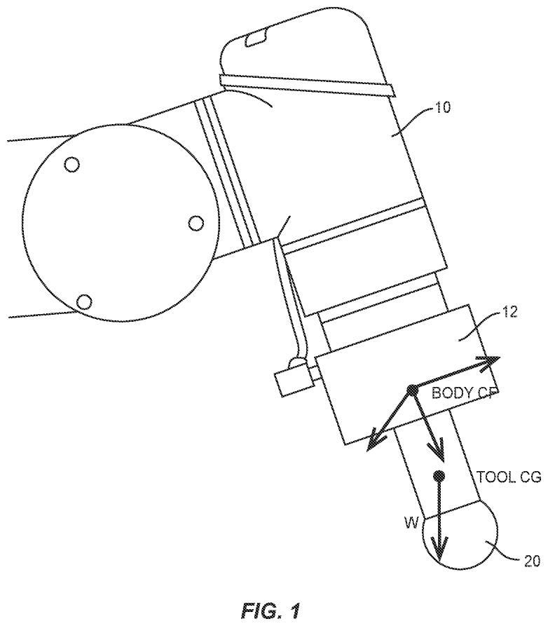

FIG. 1 depicts part of an arm of a robot 10 with a Force/Torque (F/T) sensor 12 attached. As used herein, the term robot 10 refers to both the physical robot arm, and the robot control system that controls its operation. Attached to the other side of the F/T sensor 12 is an end effector tool 20. The tool 20 may, for example, be a grinder or polishing tool that contacts and applies a predetermined force/torque vector (known in the robotic arts as a “wrench”) to a workpiece (not shown), such as for shaping the workpiece or finishing its surface(s). In general, the workpiece may have a complex shape, and the robot 10 may move the tool 20 over the workpiece surface(s) by translating and rotating along various degrees of freedom, to place the tool 20 in various orientations and spatial positions, so that it can operate on the workpiece. As the tool 20 assumes different orientations, the F/T sensor experiences differing components of the weight of the tool 20 along the axes of the sensor 12. Additionally, the robot 10 movement induces inertial forces and/or torques on the F/T sensor 12. These effects are indistinguishable, at the transducer level, from the contact forces and torques between the tool 20 and workpiece, which the F/T sensor 12 is supposed to measure. Unless they can be compensated, gravitational and inertial effects can make force control robotic operations difficult or impossible.

Dynamic Compensation

According to embodiments of the present invention, one or both of gravitational and inertial effects are dynamically compensated by an F/T sensor 12—either stand-alone, with integrated inertial measurement unit (IMU), or in conjunction with an external compensation unit, which receives data from both the F/T sensor 12 and the robot 10. The measurement compensation is performed by adding correcting factors to the F/T sensor 12 measurement outputs, where the correcting factors are based on a model of how the F/T measurement is affected by various environmental factors. Note that this disclosure does not consider temperature compensation. As mentioned above, there are known techniques to compensate for temperature drift, and temperature effects are independent of gravitational and inertial effects. The basic compensation equation is given by equation (1).

\vec{F}_{measured}=\vec{F}_{contact}+\vec{F}_{gravity}+\vec{F}ᵢₙₑᵣₜᵢₐₗ+\vec{F}ₙₒᵢₛₑ (1)

where \vec{F}_{measured} is the output of the F/T sensor;

\vec{F}_{contact} is the contact force (e.g., between a robotic tool 20 and a workpiece);

\vec{F}_{gravity} is the force applied by tooling 20 (and sensor 12) sprung-mass weight due to gravity;

\vec{F}ᵢₙₑᵣₜᵢₐₗ is the force arising from linear and/or angular acceleration, or angular velocity, of the robot arm 10; and

\vec{F}ₙₒᵢₛₑ is noise from electrical and/or mechanical sources.

Throughout this disclose, for convenience the matrix F is used to refer to both force and torque components. Where an F or T notation refers to a matrix of only force or torque terms, respectively, this will be explicitly stated, or it will be apparent to those of skill in the art from the context. Furthermore, this disclosure does not follow the strict Plücker basis, but places linear terms above rotational terms. Accordingly, each “F” term in equation (1) is a spatial vector containing the information as depicted in equation (2):

$${\vec{F}}_{description} = ( \begin{matrix}{F}_{{x}_{description}} \\ {F}_{{y}_{description}} \\ {F}_{{z}_{description}} \\ {T}_{{x}_{description}} \\ {T}_{{y}_{description}} \\ {T}_{{z}_{description}}\end{matrix} ) \qquad ( 2 )$$

In force control robotic operations, the contact force is the desired measured quantity. Accordingly, equation (1) is rewritten to yield this value. Furthermore, assume low-pass filtering is effective to eliminate the \vec{F}ₙₒᵢₛₑ term.

\vec{F}_{contact}=\vec{F}_{measured}−\vec{F}_{gravity}−\vec{F}ᵢₙₑᵣₜᵢₐₗ (3)

Equation (3) represents full compensation—referred to as Active Dynamic Compensation, as it is continuously applied—including both gravitational and inertial compensation components. According to one embodiment, the F/T sensor 12 may be equipped or configured to perform any of three levels of compensation. First, the F/T sensor 12 may perform no compensation, also known in the art as “static compensation.” This is the default setting of an F/T sensor 12. Static compensation is characterized by equation (4):

\vec{F}_{contact}=\vec{F}_{measured} (4)

Second, the F/T sensor 12 may perform only gravitational compensation. This is referred to as Active Gravitational Compensation because it occurs continuously, and it is characterized by equation (5):

\vec{F}_{contact}−\vec{F}_{measured}−\vec{F}_{gravity} (5)

Finally, as discussed above, Active Dynamic Compensation includes both gravitational and inertial compensation, and is characterized by equation (3).

Gravity Compensation

FIG. 1 depicts the robotic tool 20 in one particular orientation. As used herein, the “orientation” of the tool 20 refers to its location and attitude in 3-dimensional space, in an inertial reference frame (also referred to as the gravitational reference frame). In the inertial reference frame, one axis is always vertical (e.g., z), and the other two are always horizontal. The weight of the tool 20 is modeled as a vector from the center of gravity (CG) of the tool, pointing towards the center of the Earth. In the inertial reference frame, the weight vector of the tool 20 is always parallel to the vertical axis.

The F/T sensor 12 defines an F/T sensor body Coordinate Frame (CF)—that is, mutually orthogonal x, y, and z axes with an origin in the F/T sensor 12. The F/T sensor body CF translates and rotates through space as the robot arm moves, yet remains fixed as viewed by the F/T sensor 12. The F/T sensor 12 reports forces and torques referenced to its body CF.

The magnitude of the tool 20 weight vector, and a rotation matrix relating the inertial reference frame to the F/T sensor body CF, are the only quantities needed to compensate F/T sensor 12 force measurements for the effect of the tool 20 weight. Calculating gravitational torque compensation terms requires the additional datum of the positional offset between the tool 20 center of gravity (CG) and the F/T sensor body CF origin. The complete gravitational compensation matrix is defined in equation (6):

$${\vec{F}}_{gravity} = ( \begin{matrix}{R}_{Inertial CF}^{Body CF} & {\vec{W}}_{tool} \\ S ( {\vec{r}}_{CG} ) {R}_{Inertial CF}^{Body CF} & {\vec{W}}_{tool}\end{matrix} ) \qquad ( 6 )$$

where R_{International CF}^{Body CF} is the rotation matrix from the F/T sensor body CF to the inertial reference frame. This may be obtained from an output of an onboard inertial measurement unit (IMU) (e.g., the quaternion orientation output), or alternatively from forward kinematics of the robot 10. This value is updated every time the IMU or forward kinematics is sampled, which during use occurs at a high frequency relative to the rate of change of the tool 20 orientation (e.g., up to 400 Hz).
\vec{W}ₜₒₒₗ is the weight vector of the tool 20 in the inertial reference frame. When used without vector notation, the variable \vec{W}ₜₒₒₗ is the scalar weight of the tool 20. Accordingly, \vec{W}ₜₒₒₗ=[0 0 Wₜₒₒₗ] where z is the vertical axis in the inertial reference frame. This value may be entered by a user, or may be obtained by parameter identification.
\vec{r}_{CG} is a vector from the F/T sensor body CF origin to the tool 20 CG. S(\vec{r}_{CG}) denotes the skew-symmetric matrix of \vec{r}_{CG}. The \vec{r}_{CG} value may be entered by a user, or may be obtained by parameter identification.

Parameter identification refers to a data-driven method of obtaining important physical properties of a system from available measurements. Parameter identification is also known as system identification in robotics and control system literature. Measurement of \vec{W}ₜₒₒₗ and \vec{r}_{CG} by parameter identification is described below.

Many F/T sensors 12 exhibit muted sensitivity and/or accuracy in one or more of the six F/T measurements, due to the geometry of their construction, the distribution and orientation of strain gages, and the like. Accordingly, to obtain the most accurate measurements of \vec{W}ₜₒₒₗ, and \vec{r}_{CG} (and hence obtain the most accurate gravitational compensation), the quantities are best measured numerous times, with the F/T sensor 12 in a different spatial orientation each time. The resulting data sets are then fitted, such as by using a least squares regression, to obtain the final \vec{W}ₜₒₒₗ, and \vec{r}_{CG} values. As in all least squares regressions, the greatest accuracy is obtained if the samples are well spaced throughout their dynamic ranges. While it is possible to obtain usable gravitational compensation terms from only one tool 20 orientation and measurement, accuracy improves (e.g., noise is averaged out) as the number of discrete orientations sampled increases, up to about six. More than six tool 20 orientation measurements increase computational complexity, but add little improvement in accuracy.

Gravity Compensation of Force Terms

The force terms are gravity-compensated by knowing only the weight of the tool, which is referenced to the F/T sensor body CF to obtain the gravity compensation terms, for each axis. The resolved force measurements, which are referenced to the F/T sensor body CF, are then compensated for the weight of the tool 20 by subtracting the gravity compensation terms.

To determine the weight of the tool 20 by parameter identification, the robot 10 is commanded to place the tool 20 in j different spatial orientations (j=1, 2, . . . , n). The forces experienced at each of these orientations, from the weight of the attached tool 20, are resolved from F/T sensor transducers. Additionally, a unit gravity vector is obtained for each orientation. The unit gravity vector decomposes a weight vector of magnitude one—which is always directed downward along the vertical axis in the inertial reference frame—to its components along the three axes of the F/T sensor body CF at that orientation. The gravity unit vector for the

j^{th} orientation is denoted

$${\vec{g}}_{{measured}_{j}} = ( \begin{matrix}{g}_{{x}_{j}} \\ {g}_{{y}_{j}} \\ {g}_{{z}_{j}}\end{matrix} ) .$$

The resolved force measurements are then described by equation (7) (where the F here denotes only force terms; no torque terms):

\vec{F}_{measured},=\vec{W}ₜₒₒₗ\vec{g}_{measured}, (7)

When the j sample sets are stacked together, a least squares matrix equation is solved to minimize the square residual. It is known that if A is an m×n matrix and b is a vector in R^{m}, the least-squares solution of Ax=b are the solutions to the matrix equation A^{T}Ax=A^{T}b. As applied to equation (7), this yields equation (8):

Wₜₒₒₗ=((G^{T}G)⁻¹(G^{T}F_{measured})) (8)

where F_{measured} is the stacked gravity matrix vector

$${F}_{measured} = ( \begin{matrix}{{F}^{\to T}}_{{measured}_{1}} \\ {{F}^{\to T}}_{{measured}_{2}} \\ ⋮ \\ {{F}^{\to T}}_{{measured}_{j}}\end{matrix} )$$

and
G is the stacked gravity matrix vector

$$G = ( \begin{matrix}{{g}^{\to T}}_{{measured}_{1}} \\ {{g}^{\to T}}_{{measured}_{2}} \\ ⋮ \\ {{g}^{\to T}}_{{measured}_{j}}\end{matrix} ) .$$

Note that the weight of an attached tool 20 may not be a static quantity. For example, a grinder or sander may lose abrasive as it operates. Furthermore, a robot may change tools 14 over the course of an overall force control operation (e.g., change from a grinding tool 20 to a polishing tool 20, where both contact forces are fed back to control robot 10 positioning). As another example, a robotic tool 20 may comprise a gripper that picks up an item, moves it, and places it. If force control is required throughout, different values of Wₜₒₒₗ would apply while the tool 20 holds the item, than after it places it. In one embodiment, a plurality of values of tool weight may be entered or derived through the above-described parameter identification procedure. These values may be stored in memory and recalled for use in equation (6) as required.

Gravity Compensation of Torque Terms

The vector \vec{r}_{CG} from the F/T sensor body CF origin to the tool CG can only be measured from the torque values. The torque equation (9) follows from Newtonian physics:

\vec{T}_{measured},=\vec{r}_{CG}x(Wₜₒₒₗ\vec{g}_{measured}) (9)

This is rearranged into the Ax=b form for least squares regression using cross product identities and the skew symmetric matrix:

\vec{T}_{measured},=Wₜₒₒₗ(\vec{g}_{measured},\vec{r}_{CG}x) (10)

Let Aⱼ=−S(g_{measured}) where j is the measurement/orientation index and Aⱼ is:

$${A}_{j} = ( \begin{matrix}0 & {g}_{zj} & - {g}_{yj} \\ - {g}_{zj} & 0 & {g}_{xj} \\ {g}_{yj} & - {g}_{xj} & 0\end{matrix} ) \qquad ( 11 )$$

The least squares formulation is then:

\vec{T}_{measured},=\vec{W}ₜₒₒₗAⱼ\vec{r}_{CG} (12)

The vector from the F/T sensor body CF origin to the tool 20 CG is solved using j samples and fitting the data according to equation 13:

$${{\vec{r}}_{CG}}^{T} = \frac{1}{{W}_{tool}} ( {( {A}^{T} A )}^{- 1} ( {A}^{T} {T}_{measured} ) ) \qquad ( 13 )$$

where

$${T}_{measured} = ( \begin{matrix}{{T}^{\to T}}_{{measured}_{1}} \\ {{T}^{\to T}}_{{measured}_{2}} \\ ⋮ \\ {{T}^{\to T}}_{{measured}_{j}}\end{matrix} )$$

is the stacked matrix of torque measurements; and

$$A = ( \begin{matrix}{A}_{1} \\ {A}_{2} \\ ⋮ \\ {A}_{j}\end{matrix} ) .$$

To eliminate noise and obtain a better estimate of the tool CG, in one embodiment, a plurality of values of the vector from the F/T sensor CF origin to the tool CG may be entered or derived through the above-described parameter identification procedure. These values may be stored in memory and recalled for use in equation (6) as required.

Inertial Compensation

The inertial compensation term is considerably more complex than the gravitational compensation case, as it includes inertial, Coriolis, and centripetal coupling terms. The inverse-dynamical model of the tool 20 with respect to F/T sensor body CF can be found by application of Newton-Euler mechanics. Assuming a rigid-body model of the tool 20, the following model is derived using the following classical Newton Euler assumptions:
By Newton's 3^{rd} Law, the reaction wrench measured by the F/T sensor 12 will be equal and opposite to that experienced by the tool 20.
The total force on the system is equal to the time rate of change of the linear momentum.
The total torque on the system is equal to the time rate of change of the angular momentum.

The total force and torque on the F/T sensor body CF, excluding gravitational terms, are given by equations (14) and (15), respectively:

\vec{F}ᵢₙₑᵣₜₐᵢₗ=m\vec{α}+m(\dot{ω}×\vec{r}_{CG})+m(\vec{ω}×(\vec{ω}×\vec{r}_{CG})) (14)

\vec{T}ᵢₙₑᵣₜᵢₐₗ=I\dot{ω}+\vec{ω}×(I\vec{ω})+m(\dot{ω}×\vec{r}_{CG})+m(\vec{r}_{CG}×\vec{α}) (15)

where m is the mass of the tool 20. This term can be obtained from the gravitational compensation parameter identification, by converting weight to mass

$$( m = \frac{{W}_{tool}}{9.8 N / kg} ) .$$

\dot{ω} is the angular velocity of the F/T sensor body CF. This may be obtained from data output by the onboard IMU, or alternatively from forward kinematics of the robot 10.
\dot{ω} is the angular acceleration of the F/T sensor body CF. This may be differentiated from IMU data, or alternatively from forward kinematics of the robot 10.
\vec{r}_{CG} is the vector from the F/T sensor body CF origin to the tool 20 CG. This value may be entered by a user, or may be obtained by parameter identification as described above for gravitational compensation.
\vec{a} is the linear acceleration of the F/T sensor body CF. An onboard IMU outputs an acceleration value, which comprises both gravitational acceleration and linear acceleration. The linear acceleration may be extracted by estimating the gravitational acceleration from absolute orientation data that is transformed into an estimated gravity vector. With this estimated gravity vector, the linear acceleration is computed as \vec{α}=\vec{α}_{IMU}−\vec{g}ₑₛₜᵢₘₐₜₑ. Alternatively, \vec{α} may be obtained from robot forward kinematics.
I is the inertia tensor defined in the F/T sensor body CF. An inertia tensor is a matrix containing all moments and products of inertia. Intuitively, an inertia tensor provides the transformation between angular velocity and angular momentum. This value may be entered by a user or may be obtained by parameter identification.

The force and torque vectors of equations (14) and (15) are obtained from measurements performed at j different tool 20 orientations, j=1, 2, . . . , n (although six is a reasonable upper limit for n, this is not a limitation of the present invention). Similar to the gravitational compensation case, these are then stacked into a spatial vector to create the final inertial compensation terms, according to equation (16) (where the superscript 6 refers to the dimension of the spatial vector when used around traditional coordinate vectors):

$${}^{6} {\vec{F}}_{inertial} = ( \begin{matrix}{\vec{F}}_{inertial} \\ {\vec{T}}_{inertial}\end{matrix} ) = ( \begin{matrix}m \vec{a} + m ( \dot{ω} \times {\vec{r}}_{CG} ) + m ( \vec{ω} \times ( \vec{ω} \times {\vec{r}}_{CG} ) ) \\ I \dot{ω} + \vec{ω} \times ( I \vec{ω} ) + m ( \dot{ω} \times {\vec{r}}_{CG} ) + m ( {\vec{r}}_{CG} \times \vec{a} )\end{matrix} ) \qquad ( 16 )$$

Identification of Inertial Compensation Terms

The inertia tensor I is a required term, that is difficult to quantify without solid models containing exact materials. Accordingly, in one embodiment a parameter estimation method is used to obtain the six distinct parameters of the inertia tensor.

In order to create a relation between torque measurements and the inertia tensor, the rotational inertia terms are isolated on one side.

\vec{T}^{T}_{inertial_rot}=\vec{T}^{T}_{Measured}−\vec{T}^{T}_{Grav}−\vec{T}^{T}_{inertial_lin} (17)

where \vec{T}^{T}_{Measured} is the torque measured by the 6-axis F/T sensor 12;

\vec{T}^{T}_{Grav} is the torque due to gravity acting through the center of mass (bottom of Eq. 6);

and

T_{inertial_lin} is the torque created by a linear acceleration acting through the center of mass (the m (\vec{r}_{CG}×\vec{α}) term in the bottom of Eq. 16). This leaves the rotational inertia terms to be:

\vec{T}^{T}_{inertial_rot}=I\dot{ω}+\vec{ω}×I\vec{ω} (18)

### Knowing

$$I = [ \begin{matrix}{I}_{xx} & {I}_{xy} & {I}_{xz} \\ {I}_{yz} & {I}_{yy} & {I}_{yz} \\ {I}_{zx} & {I}_{zy} & {I}_{zz}\end{matrix} ] \qquad ( 19 )$$

### Let

I_{xy}=I_{yx},I_{xz}=I_{zx}, and I_{zy}=I_{yz} (20)

such that there are now only six unique inertial parameters. If the angular velocity and angular acceleration are given by

\vec{ω}=(ωₓ,ω_{y},ω_{z}) (21)

and

\dot{ω}=\vec{α}=(αₓ,α_{y},α_{z}) (22)

Multiplying out equation 18 allows for a purely matrix form to be found.

\vec{T}^{T}_{inertial_rot}_{ᵢ}=Yᵢθ (23)

where θ is the parameter vector of inertial terms defined as

$$θ = ( \begin{matrix}{I}_{xx} \\ {I}_{yy} \\ {I}_{zz} \\ {I}_{xy} \\ {I}_{xz} \\ {I}_{yz}\end{matrix} ) \qquad ( 24 )$$

$$and$$

$${Y}_{i} = [ \begin{matrix}{α}_{x} & - {ω}_{y} {ω}_{z} & {ω}_{y} {ω}_{y} & ( {α}_{y} - {ω}_{x} {ω}_{z} ) & ( {α}_{z} - {ω}_{x} {ω}_{z} ) & ( {ω}_{y}^{2} - {ω}_{z}^{2} ) \\ {ω}_{x} {ω}_{z} & {α}_{y} & - {ω}_{x} {ω}_{z} & ( {α}_{x} + {ω}_{y} {ω}_{z} ) & ( {ω}_{z}^{2} - {ω}_{x}^{2} ) & ( {α}_{z} - {ω}_{x} {ω}_{y} ) \\ - {ω}_{x} {ω}_{y} & {ω}_{x} {ω}_{y} & {α}_{z} & ( {ω}_{x}^{2} - {ω}_{y}^{2} ) & ( {α}_{x} - {ω}_{y} {ω}_{z} ) & ( {α}_{y} + {ω}_{x} {ω}_{z} )\end{matrix} ] \qquad ( 25 )$$

And the subscript i refers to the sample at instant i.

Equation 23 can be solved in the least squared sense for θ, as

$$θ = {[ {Y}^{T} Y ]}^{- 1} ⌈ {Y}^{T} {T}_{inertial \_ rot} ⌉ \qquad ( 26 )$$

$$where$$

$$\begin{matrix}Y = ( \begin{matrix}{Y}_{1} \\ {Y}_{2} \\ ⋮ \\ {Y}_{n}\end{matrix} ) & ( 27 )\end{matrix}$$

$$and$$

$${T}_{inertial \_ rot} = ( \begin{matrix}{{T}^{\to T}}_{{inertial \_ rot}_{1}} \\ {{T}^{\to T}}_{{inertial \_ rot}_{2}} \\ ⋮ \\ {\vec{T}}_{{inertial \_ rot}_{n}}\end{matrix} ) \qquad ( 28 )$$

Each of the samples in equations 27 and 28 are generated from a complex trajectory of the robot, which involves a simultaneous rotation of the tooling mass in all three rotational axes. Each time instant generates a data point that can be used in the least squares estimation.

From an accuracy perspective, creating angular motions that excite a good range of the F/T sensor's torque rating will provide a better estimate of the inertia tensor; however the angular motions of the tooling could create stresses within the tooling that were not anticipated in the design of the tool. For this reason, the parameter estimation data gathering motion preferably does not exceed the speed of the specific use application.

The terms of the inertia tensor I, tool weight \vec{W}ₜₒₒₗ, and tool CG may not be static. For example these quantities may change as the tool 20 mass changes. In one embodiment, a plurality of values of the I, \vec{W}ₜₒₒₗ, and CG may be entered, or derived through the above-described parameter identification procedure. These values may be stored in memory and recalled for use in equation (6) as required.

Dual Mass Distribution

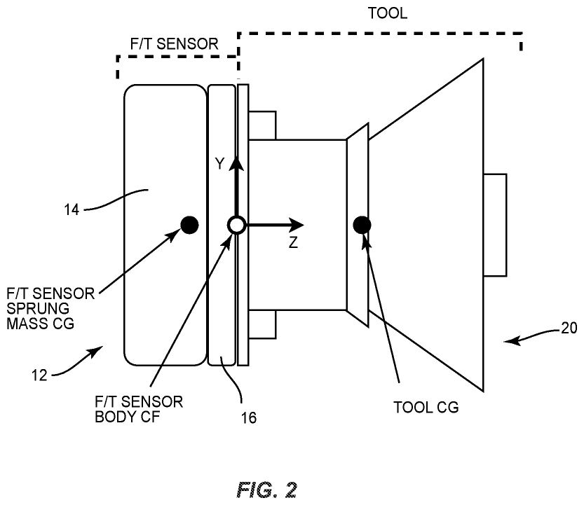

In one embodiment, the sprung mass of the F/T sensor 12 and the mass of the tool are accounted for separately. This facilitates gravitational and inertial compensation of a variety of tools to which the F/T sensor 12 may be coupled. FIG. 2 depicts an F/T sensor 12 attached to a robot arm (not shown) and a tool 20. FIG. 2 depicts the F/T sensor 12 center of gravity (CG), its body coordinate frame (CF), and the tool 20 center of gravity (CG).

In this embodiment, Eq. 3 is rewritten as

\vec{F}_{contact}=\vec{F}_{measured}−\vec{F}_{gravity-tool}−\vec{F}ᵢₙₑᵣₜᵢₐₗ₋ₜₒₒₗ−\vec{F}_{gravity-F/T}−\vec{F}_{inertial-F/T} (29)

where the subscripts identify the gravitational and inertial forces and torques derived separately for each of the tool 20 and the F/T sensor 12. These are computed separately, e.g., using the techniques described herein.

Orientation, Velocity, and Acceleration Sensing

Gravitational compensation relies on sensing the instantaneous orientation of the tool 20, and inertial compensation relies on sensing the instantaneous linear and angular velocity of the F/T sensor body CF. These values may be directly sensed by an integrated IMU, or obtained from forward kinematics of the robot 10.

Inertial Measurement Unit

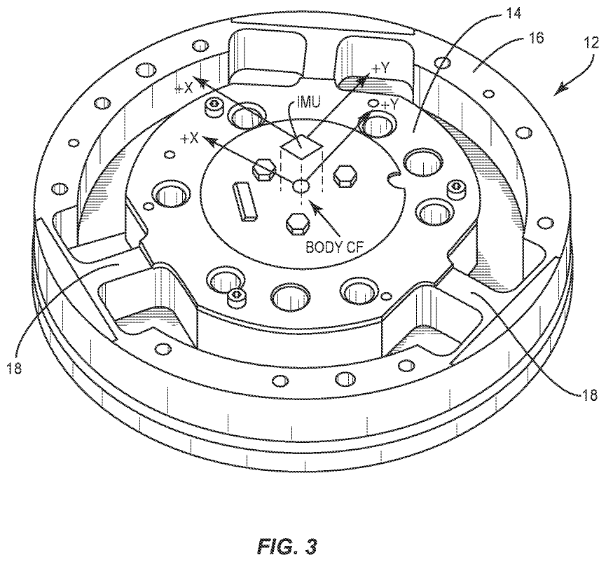

FIG. 3 depicts an F/T sensor 12 with an IMU integrated therein, such as on a circuit board. The IMU may comprise a 9-axis sensor unit integrating an accelerometer, gyroscope, magnetic sensor, and microcontroller. The IMU is positioned at the F/T sensor body CF origin, and is calibrated to align its axes with the F/T sensor body CF (for clarity, FIG. 3 is an exploded parts diagram, depicting the as IMU as “hovering” over the CF; in an assembled F/T sensor 12 the IMU is mounted to the MAP 14 at the CF origin). The IMU then provides absolute orientation and angular velocity data at a high frequency (e.g., hundreds of Hz). A suitable IMU is the BN0080/85 9-axis SIP IMU available from CEVA Technologies, Inc. of Rockville Md., https://www.ceva-dsp.com/

The F/T sensor 12 includes measurement circuitry configured to resolve force and torque measurements from the transducer signals, as well known in the robotic arts. The measurement circuitry may, for example, include processing circuitry configured by appropriate software to calculate force and torque measurements from transducer signals according to known methods, such as those described in U.S. Pat. No. 10,067,019, assigned to the assignee of the present disclosure and incorporated herein by reference in its entirety, or the above-incorporated U.S. Pat. No. 10,422,707. The measurement circuitry may additionally perform thermal compensation of force and torque measurements, as described in the above-incorporated international patent publication WO 2018/200668. The processing circuitry may be integrated into the sensor 12 body, or may be external, such as by being connected by one or more wired or wireless communication links.

According to embodiments of the present invention, the F/T sensor 12 additionally includes compensation circuitry configured to perform gravitational and/or inertial compensation of force and torque measurements. The compensation circuitry includes the IMU described above, and processing circuitry integrated with the IMU, or connected to the IMU in data transfer relationship. The processing circuitry is configured, such as by the provision of appropriate software, to receive or retrieve data from the IMU and other sources, and perform the calculations described herein to effect gravitational and/or inertial compensation of force and torque measurements.

In some embodiments, the measurement circuitry and compensation circuitry may comprise the same processing circuitry, with the configuration for resolving resolve force and torque measurements from the transducer signals, or performing gravitational and/or inertial compensation of the force and torque measurements, being by the provision of appropriate software. The processing circuitry may comprise any computational hardware known in the art, such as a dedicated state machine implemented in hardware; programmable logic together with appropriate firmware; one or more stored-program processors or Digital Signal Processors (DSP) together with appropriate software; or any combination of the above. The processing circuitry may include peripheral circuitry, such as memory, co-processors, data and/or communication interfaces, man/machine interfaces, and the like, as known in the art.

Forward Kinematics Data Processing

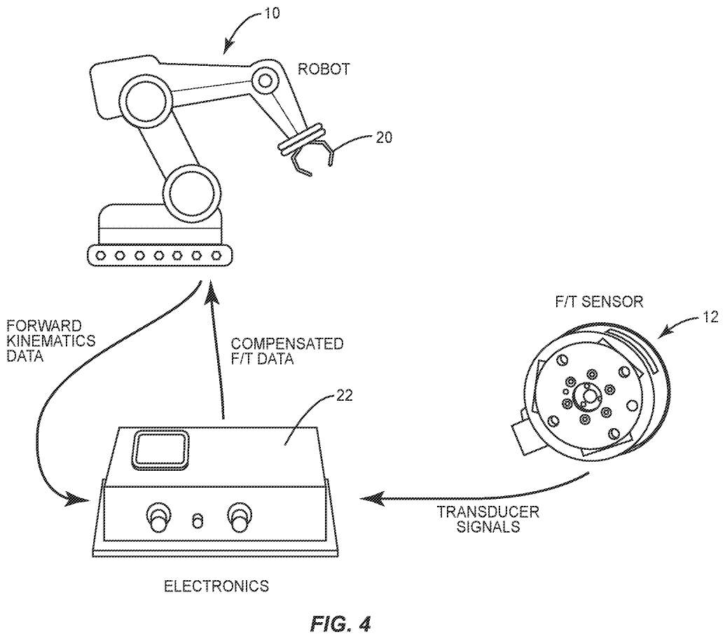

In some embodiments, due to size and/or cost constraints, it is not practical to integrate an IMU into each F/T sensor 12. In these embodiments, orientation and velocity data are obtained from forward kinematics of the robot. Forward kinematics refers to the use of the kinematic equations of a robot to compute the position, velocity, or other dynamic characteristics of the tool 20 from instantaneous values of the robot parameters, such as various joint positions. FIG. 4 depicts a block diagram of a system comprising the robot 10 and F/T sensor 12, and an external electronics module 22. The electronics module 22 receives forward kinematics data from the robot 10 (i.e., the robotic control system), and transducer signals from the F/T sensor 12. One or more processors and appropriate software within the electronics module 22 resolve the transducer signals into F/T measurements and calculate and apply gravitational and optionally inertial compensation terms. The compensated F/T data, which represents only \vec{F}_{contact}, is fed back to the robot 10 for use in force control operations. A suitable external electronics module 22 is available from ATI Industrial Automation, Inc. of Apex, NC http://www.ati-ia.com/

Methods

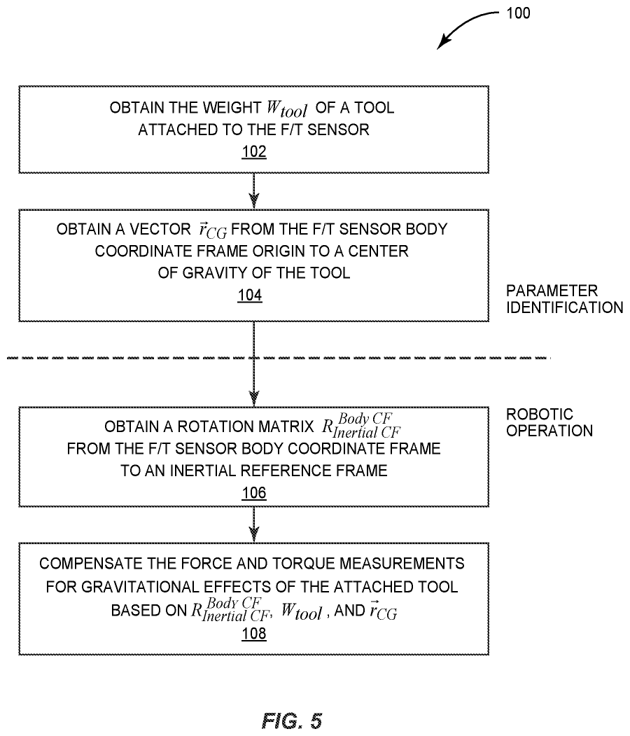

FIG. 5 depicts the steps in a method 100 of compensating force and torque measurements of a Force/Torque (F/T) sensor 12 attached to a robot 10 for gravitational effects due to the weight of an attached tool 20. The force and torque measurements are resolved from transducer output signals by measurement circuitry of the sensor 12. The force and torque measurements are referenced to a body Coordinate Frame (CF) of the F/T sensor 12. The F/T sensor 12 also includes compensation circuitry that performs the method 100. The compensation circuitry may be internal to the F/T sensor 12, such as an inertial measurement unit (IMU), or may be external electronics receiving forward kinematics data from the robot 10.

As indicated by the dashed line, the method 100 can be considered to comprise two separate phases, or modes. In a first phase, parameter identification, the weight Wₜₒₒₗ, of a tool attached to the F/T sensor 12 is obtained (block 102). Also in the first phase, a vector \vec{r}_{CG} from the F/T sensor body CF origin to a center of gravity of the tool 20 is also obtained (block 104). The data Wₜₒₒₗ, and \vec{r}_{CG} may be input by a user, or may be obtained in a parametric identification process. In the latter case, the robot 10 positions the tool 20 in one or more different orientations. The forces and torques resolved from transducers, and a unit gravity vector, are obtained at each orientation. The data Wₜₒₒₗ, and \vec{r}_{CG} are derived by fitting these data measured from one or more orientations, such as by formulating and solving a least squares regression model. A plurality of values for Wₜₒₒₗ, and \vec{r}_{CG} may be calculated and stored to account for changes in tool 20 weight or configuration during robotic operations.

In the second phase of the method 100, robotic operation (which may comprise a force control operation), a rotation matrix R_{Inertial CF}^{Body CF} from the F/T sensor body CF to an inertial reference frame is obtained (block 106) and the force and torque measurements for gravitational effects of the attached tool are compensated based on R_{Inertial CF}^{Body CF}, Wₜₒₒₗ, and \vec{r}_{CG} (block 108). R_{Inertial CF}^{Body CF} may be obtained from the internal IMU, or the external electronics. During the second phase, an updated value of R_{Inertial CF}^{Body CF} is obtained, and updated gravity compensation terms are calculated and applied to the sensor 12 force and torque measurements.

The F/T sensor 12 transducers are analog devices that continuously output signals in response to mechanical stresses. The rate at which those signals are resolved into forces and torques is set by the user and may vary according to the needs of a particular robotic operation. In one embodiment force and torque measurements have a maximum update rate of about 8 kHz. The frequency of positioning data depends on the IMU or forward kinematics processing. Although some IMU devices may output data at up to 1 kHz, very high frequency outputs contain significant noise. In one embodiment, positioning data is obtained at about 400 kHz, and the most recent positioning data is used for gravity and/or inertial compensation when each force measurement is taken. Accordingly, the compensation of measured force and torque terms for gravitational and inertial effects occurs at a high frequency relative to changes in orientation of the robotic tool 20. The values for Wₜₒₒₗ and \vec{r}_{CG} may be selected from among a plurality of stored values, in dependence on the tool selected, its estimated mass loss rate, whether it is carrying a known extra mass, and the like.

In a further refinement of the method 100 (not shown), the force and torque measurements are additionally compensated for inertial effects due to movement of the robot 10. The mass m of the tool is obtained in the first phase of the method 100. In the second phase, during robotic operation, the following properties of the F/T sensor body CF are additionally obtained: its angular velocity \vec{ω}; its angular acceleration \dot{ω}; and its linear acceleration \vec{α}. The terms of an inertia tensor I defined in the F/T sensor body CF are also updated. The inertia tensor I comprises a matrix containing all moments and products of inertia. In the second phase, inertial compensation terms are calculated and also applied to the sensor 12 force and torque measurements, at the same frequency as gravity compensation terms. In robotic operations where the effective mass or size of the tool may change, appropriate values for relevant parameters, such as I, \vec{W}ₜₒₒₗ, CG, or others may be selected from among a plurality of stored values.

Results

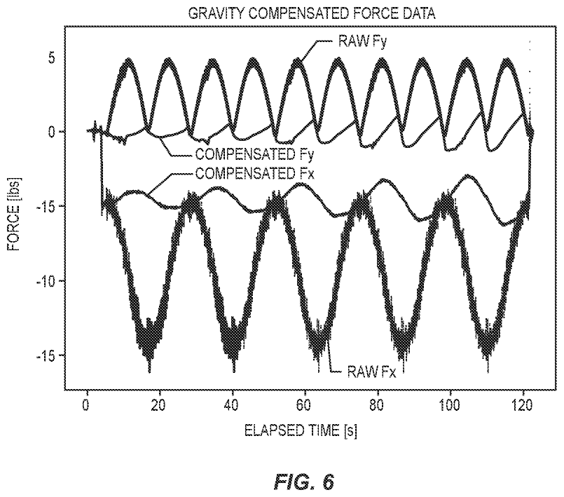

FIG. 6 depicts the dramatic improvement to force measurements that gravity compensation can achieve. The robotic operation depicted was sanding the outer surface of a pipe, with a desired contact force F_{contact} of 5 lbs. Both the raw and gravity-compensated force components Fx and Fy are graphed (both raw and compensated Fz curves were close to zero; these are omitted from the graph for clarity). In both cases, the gravity-compensated data are swamped by the magnitude of fluctuations in the raw data—in the case of Fx, by nearly 4x! This is an example where a force control robotic operation may not even be possible using uncompensated force measurements. By compensating the Fx and Fy measurements resolved from transducer output signals to account for effects due to the weight of the tool, useful contact force information can be extracted from the data. Note that the compensated data in FIG. 6 include only gravitational compensation; applying inertial compensation would additionally remove the effects of robotic movement from the measured data.

Embodiments of the present invention present numerous advantages over the prior art. By obtaining orientation data from an IMU or forward kinematics, embodiments of the present invention provide on-going, high-speed compensation of measured forces and torques for gravitational and inertial effects. By using parameter identification methods, quantities such as tool weight and a vector from the F/T sensor CF origin to the tool center of gravity may be derived. As FIG. 6 shows, the apparatus and methods described and claimed herein dramatically improve raw force and torque measurement from a robotic F/T sensor.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to.”

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A robotic force/torque (F/T) sensor including transducers configured to generate signals in response to forces or torques applied to the sensor, comprising:
measurement circuitry configured to resolve force and torque measurements from the transducer signals, the force and torque measurements referenced to a body Coordinate Frame (CF) of the F/T sensor; and
compensation circuitry configured to
obtain the weight Wₜₒₒₗ, of an attached tool;
obtain a vector \vec{r}_{CG} from the F/T sensor body CF origin to a center of gravity of the tool;
obtain a rotation matrix R_{Inertial CF}^{Body CF} from the F/T sensor body CF to an inertial reference frame; and
compensate the force and torque measurements for gravitational effects of the attached tool based on R_{Inertial CF}^{Body CF}, Wₜₒₒₗ, and \vec{r}_{CG}.

2. The F/T sensor of claim 1 wherein the compensation circuitry comprises:
an inertial measurement unit integrated with the F/T sensor and calibrated to be in the F/T sensor body CF; and
processing circuitry coupled to the inertial measurement unit in data transfer relationship, and configured to perform compensation calculations.

3. The F/T sensor of claim 1 wherein the compensation circuitry comprises circuitry external to the F/T sensor, the external circuitry configured to:
receive forward kinematics data from a robot to which the F/T sensor is attached;
receive transducer signals from the F/T sensor; and
output gravity-compensated force and torque measurements.

4. The F/T sensor of claim 1 wherein the compensation circuitry is configured to perform gravity compensation of force and torque measurements by continuously calculating
\vec{F}_{contact}=\vec{F}_{measured}−\vec{F}_{gravity}
where each \vec{F} is a spatial vector,
$$\vec{F} = ( \begin{matrix}{F}_{x} \\ {F}_{y} \\ {F}_{z} \\ {T}_{x} \\ {T}_{y} \\ {T}_{z}\end{matrix} ) ,$$
and where F is Force and T is Torque and the
subscript identifies an axis; and
where \vec{F}_{contact} are the gravity-compensated F/T measurements;
\vec{F}_{measured} are force and torque measurements resolved from the F/T sensor transducers; and
\vec{F}_{gravity} are compensation terms accounting for the effects of gravity due to the attached tool.

5. The F/T sensor of claim 4 where
$${\vec{F}}_{gravity} = ( \begin{matrix}{R}_{Inertial CF}^{Body CF} & {\vec{W}}_{tool} \\ S ( {\vec{r}}_{CG} ) {R}_{Inertial CF}^{Body CF} & {\vec{W}}_{tool}\end{matrix} )$$
\vec{W}ₜₒₒₗ is the weight vector of the attached tool in the inertial reference frame; and
S(•) denotes a skew-symmetric matrix operation.

6. The F/T sensor of claim 1 wherein the compensation circuitry is further configured to:
obtain a mass m of the attached tool;
obtain an angular velocity \vec{ω} of the F/T sensor body CF;
obtain an angular acceleration \dot{ω} of the F/T sensor body CF;
obtain a linear acceleration \vec{α} of the F/T sensor body CF;
obtain the inertia tensor I defined in the F/T sensor body CF which contains all moments and products of inertia; and
further compensate the force and torque measurements for inertial effects of movement of the robot based on m, \vec{ω}, \dot{ω}, \vec{r}_{CG}, \vec{α}, and I.

7. The F/T sensor of claim 6 wherein the compensation circuitry is configured to perform gravity and inertial compensation of force and torque measurements by continuously calculating
\vec{F}_{contact}=\vec{F}_{measured}−\vec{F}_{gravity}−\vec{F}ᵢₙₑᵣₜᵢₐₗ.

8. The F/T sensor of claim 7 wherein
$${}^{6} {\vec{F}}_{inertial} = ( \begin{matrix}{\vec{F}}_{inertial} \\ {\vec{T}}_{inertial}\end{matrix} ) = ( \begin{matrix}m \vec{a} + m ( \dot{ω} \times {\vec{r}}_{CG} ) + m ( \vec{ω} \times ( \vec{ω} \times {\vec{r}}_{CG} ) ) \\ I \dot{ω} + \vec{ω} \times ( I \vec{ω} ) + m ( \dot{ω} \times {\vec{r}}_{CG} ) + m ( {\vec{r}}_{CG} \times \vec{a} )\end{matrix} ) .$$

9. The F/T sensor of claim 7 wherein the gravitational and inertial compensation are performed separately for the F/T sensor the attached tool, according to:
\vec{F}_{contact}=\vec{F}_{measured}−\vec{F}_{gravity-tool}−\vec{F}ᵢₙₑᵣₜᵢₐₗ₋ₜₒₒₗ−\vec{F}_{gravity-F/T}−F_{inerthal-F/T},
where \vec{F}_{graviy-tool} and \vec{F}ᵢₙₑᵣₜᵢₐₗ₋ₜₒₒₗ are the respective gravitational and inertial compensations for the tool, and
\vec{F}_{graviy-tool} and \vec{F}ᵢₙₑᵣₜᵢₐₗ₋ₜₒₒₗ are the respective gravitational and inertial compensations for the F/T sensor.

10. A method of compensating force and torque measurements resolved from transducer output signals of a robotic Force/Torque (F/T) sensor by measurement circuitry for gravitational effects due to the weight of an attached tool, the force and torque measurements referenced to a body Coordinate Frame (CF) of the F/T sensor, wherein the F/T sensor includes compensation circuitry, the method comprising:
obtaining the weight Wₜₒₒₗ of a tool attached to the F/T sensor;
obtaining a vector \vec{r}_{CG} from the F/T sensor body CF origin to a center of gravity of the tool;
obtaining a rotation matrix R_{Inertial CF}^{Body CF} from the F/T sensor body CF to an inertial reference frame; and
compensating the force and torque measurements for gravitational effects of the attached tool based on R_{Inertial CF}^{Body CF}, Wₜₒₒₗ, and \vec{r}_{CG}.

11. The method of claim 10 wherein obtaining Wₜₒₒₗ and \vec{r}_{CG} occur in a parametric identification procedure, and obtaining R_{Inertial CF}^{Body CF} and compensating the force and torque measurements occur during a robotic operation at a high frequency relative to change in orientation and movement of the robotic tool.

12. The method of claim 10 wherein the compensation circuitry is external to the F/T sensor and wherein obtaining Wₜₒₒₗ and \vec{r}_{CG} comprises determining them based on forward kinematics data from the robot.

13. The method of claim 10 wherein the compensation circuitry comprises an inertial measurement unit (IMU) in the F/T sensor that is aligned with the F/T sensor body CF and wherein obtaining Wₜₒₒₗ and \vec{r}_{CG} comprises determining them based on data from the IMU.

14. The method of claim 10 wherein compensating the force and torque measurements for gravitational effects of the attached tool based on R_{Inertial CF}^{Body CF}, Wₜₒₒₗ, and \vec{r}_{CG} comprises continuously calculating
\vec{F}_{contact}=\vec{F}_{measured}−\vec{F}_{gravity} where
each F is a spatial vector,
$$\vec{F} = ( \begin{matrix}{F}_{x} \\ {F}_{y} \\ {F}_{z} \\ {T}_{x} \\ {T}_{y} \\ {T}_{z}\end{matrix} ) ;$$
\vec{F}_{contact} are the gravity-compensated F/T measurements;
\vec{F}_{measured} are force and torque measurements resolved from the F/T sensor transducers;
$${\vec{F}}_{gravity} = ( \begin{matrix}{R}_{Inertial CF}^{Body CF} & {\vec{W}}_{tool} \\ S ( {\vec{r}}_{CG} ) {R}_{Inertial CF}^{Body CF} & {\vec{W}}_{tool}\end{matrix} )$$
are compensation terms accounting for the effects of gravity due to the weight of the attached tool; and where
S (•) denotes a skew-symmetric matrix operation.

15. The method of claim 10 wherein obtaining Wₜₒₒₗ comprises:
positioning the tool in a number j of different orientations, j=1, 2, . . . , n, and for each such orientation:
resolving the force terms of
$${\vec{F}}_{{measured}_{j}} = ( \begin{matrix}{F}_{{x}_{j}} \\ {F}_{{y}_{j}} \\ {F}_{{z}_{j}}\end{matrix} )$$
from F/T sensor transducer outputs;
obtaining a unit gravity vector
$${\vec{g}}_{{measured}_{j}} = ( \begin{matrix}{g}_{{x}_{j}} \\ {g}_{{y}_{j}} \\ {g}_{{z}_{j}}\end{matrix} )$$
decomposing a unit vector
directed downwardly in the inertial reference frame to its components along axes of the F/T sensor body CF; and
determining \vec{W}ₜₒₒₗ by data fitting the j matrices of \vec{F}_{measured} and \vec{g}_{measured} according to
\vec{F}_{measured}_{ⱼ},=Wₜₒₒₗ\vec{g}_{measured}_{ⱼ}.

16. The method of claim 15 wherein determining \vec{W}ₜₒₒₗ by data fitting the j matrices of \vec{F}_{measured} and \vec{g}_{measured} comprises computing a least squares solution according to
$${\vec{W}}_{tool} = ( {( {G}^{T} G )}^{- 1} ( {G}^{T} {F}_{measured} ) )$$
$$where {F}_{measured} = ( \begin{matrix}{{F}^{\to T}}_{{measured}_{1}} \\ {{F}^{\to T}}_{{measured}_{2}} \\ ⋮ \\ {{F}^{\to T}}_{{measured}_{j}}\end{matrix} ) and G = ( \begin{matrix}{{g}^{\to T}}_{{measured}_{1}} \\ {{g}^{\to T}}_{{measured}_{2}} \\ ⋮ \\ {{g}^{\to T}}_{{measured}_{j}}\end{matrix} ) .$$

17. The method of claim 15 wherein obtaining \vec{r}_{CG} comprises:
for each of the j tool orientations, resolving the torque terms of
$${\vec{T}}_{{measured}_{j}} = ( \begin{matrix}{T}_{{x}_{j}} \\ {T}_{{y}_{j}} \\ {T}_{{z}_{j}}\end{matrix} )$$
from F/T sensor transducer outputs; and
determining \vec{r}_{CG} by data fitting the j matrices of \vec{T}_{measured} and g_{measured} according to
\vec{T}_{measured}=\vec{r}CG×(Wₜₒₒₗ\vec{g}_{measured},).

18. The method of claim 17 wherein determining \vec{r}_{CG} by data fitting the j matrices of \vec{T}_{measured} and \vec{g}_{measured} comprises computing a least squares solution according to
$${{\vec{r}}_{CG}}^{T} = \frac{1}{{W}_{tool}} ( {( {A}^{T} A )}^{- 1} ( {A}^{T} {T}_{measured} ) ) where$$
$${T}_{measured} = ( \begin{matrix}{{T}^{\to T}}_{{measured}_{1}} \\ {{T}^{\to T}}_{{measured}_{2}} \\ ⋮ \\ {{T}^{\to T}}_{{measured}_{j}}\end{matrix} ) and A = ( \begin{matrix}{A}_{1} \\ {A}_{2} \\ ⋮ \\ {A}_{j}\end{matrix} ) where each$$
$${A}_{j} = - S ( {\vec{g}}_{{measured}_{j}} ) = ( \begin{matrix}0 & {g}_{zj} & - {g}_{yj} \\ - {g}_{zj} & 0 & {g}_{xj} \\ {g}_{yj} & - {g}_{xj} & 0\end{matrix} ) .$$

19. The method of claim 10 further comprising compensating the force and torque measurements resolved from transducer output signals for inertial effects due to movement of the robot, the method further comprising:
obtaining the mass m of the tool;
obtaining the angular velocity \vec{ω} of the F/T sensor body CF;
obtaining the angular acceleration \dot{ω} of the F/T sensor body CF;
obtaining the linear acceleration \vec{α} of the F/T sensor body CF;
obtaining the inertia tensor I defined in the F/T sensor body CF, I comprising a matrix containing all moments and products of inertia; and
compensating the force and torque measurements for inertial effects due to movement of the robot based on m, \vec{ω}, \dot{ω}, \vec{r}_{CG}, \vec{α}, and I.

20. The method of claim 19 wherein the compensation circuitry is external to the F/T sensor and wherein obtaining \vec{ω}, \dot{ω}, rc_{G}, and \vec{α} comprises determining them based on forward kinematics data from the robot.

21. The method of claim 19 wherein the compensation circuitry comprises an inertial measurement unit (IMU) in the F/T sensor that is aligned with the F/T sensor body CF and wherein obtaining \vec{ω}, \dot{ω}, rc_{G}, and \vec{α} comprises determining them based on data from the IMU.

22. The method of claim 19 wherein compensating the force and torque measurements for inertial effects due to movement of the robot based on m, \vec{ω}, \dot{ω}, \vec{r}_{CG}, \vec{α}, and I comprises continuously calculating
$${\vec{F}}_{contact} = {\vec{F}}_{measured} - {\vec{F}}_{gravity} - {\vec{F}}_{inertial} where$$
$${}^{6} {\vec{F}}_{inertial} = ( \begin{matrix}{\vec{F}}_{inertial} \\ {\vec{T}}_{inertial}\end{matrix} ) = ( \begin{matrix}m \vec{a} + m ( \dot{ω} \times {\vec{r}}_{CG} ) + m ( \vec{ω} \times ( \vec{ω} \times {\vec{r}}_{CG} ) ) \\ I \dot{ω} + \vec{ω} \times ( I \vec{ω} ) + m ( \dot{ω} \times {\vec{r}}_{CG} ) + m ( {\vec{r}}_{CG} \times \vec{a} )\end{matrix} )$$

23. The method of claim 22 further comprising relating torque measurements to I according to
\vec{T}^{T}_{inertial_rot}\vec{=\vec{T}^{T}}_{Measured}−\vec{T}^{T}_{Grav}−\vec{T}^{T}_{inertial_lin}
where \vec{T}^{T}_{Measured} is the torque measured by the 6-axis F/T sensor 12;
\vec{T}^{T}_{Grav} is the torque due to gravity acting through the center of mass;
\vec{T}^{T}_{inertial_lin} is the torque created by a linear acceleration acting through the center of mass; and thus the rotational inertial compensation term \vec{T}^{T}_{inertial_rot} is \vec{T}^{T}_{inertial_rot}+I\dot{ω}+\vec{ω}+I\vec{ω}

24. The method of claim 22 further comprising expressing the rotational inertial compensation term \vec{T}^{T}_{inertial_rot} as
\vec{T}^{T}_{inertial_rot}=Y,θ
where θ is the parameter vector of inertial terms defined as
$$θ = ( \begin{matrix}{I}_{xx} \\ {I}_{yy} \\ {I}_{zz} \\ {I}_{xy} \\ {I}_{xz} \\ {I}_{yz}\end{matrix} )$$
$$and$$
$${Y}_{i} = [ \begin{matrix}{α}_{x} & - {ω}_{y} {ω}_{z} & {ω}_{y} {ω}_{y} & ( {α}_{y} - {ω}_{x} {ω}_{z} ) & ( {α}_{z} - {ω}_{x} {ω}_{z} ) & ( {ω}_{y}^{2} - {ω}_{z}^{2} ) \\ {ω}_{x} {ω}_{z} & {α}_{y} & - {ω}_{x} {ω}_{z} & ( {α}_{x} + {ω}_{y} {ω}_{z} ) & ( {ω}_{z}^{2} - {ω}_{x}^{2} ) & ( {α}_{z} - {ω}_{x} {ω}_{y} ) \\ - {ω}_{x} {ω}_{y} & {ω}_{x} {ω}_{y} & {α}_{z} & ( {ω}_{x}^{2} - {ω}_{y}^{2} ) & ( {α}_{x} - {ω}_{y} {ω}_{z} ) & ( {α}_{y} + {ω}_{x} {ω}_{z} )\end{matrix} ] ,$$
solving the rotational inertial compensation term formulation \vec{T}^{T}_{inertial_rot}=Yᵢθ using a least squares formulation
$$θ = {[ {Y}^{T} Y ]}^{- 1} ⌈ {Y}^{T} {T}_{inertial \_ rot} ⌉$$
$$where$$
$$Y = ( \begin{matrix}{Y}_{1} \\ {Y}_{2} \\ ⋮ \\ {Y}_{n}\end{matrix} )$$
$$and$$
$${T}_{inertial \_ rot} = ( \begin{matrix}{{T}^{\to T}}_{{inertial \_ rot}_{1}} \\ {{T}^{\to T}}_{{inertial \_ rot}_{2}} \\ ⋮ \\ {{T}^{\to T}}_{{inertial \_ rot}_{n}}\end{matrix} ) .$$

25. The method of claim 14 wherein the gravitational and inertial compensation are performed separately for the F/T sensor the attached tool, according to:
\vec{F}_{contact}=\vec{F}_{measured}−\vec{F}_{gravity-tool}−\vec{F}ᵢₙₑᵣₜᵢₐₗ₋ₜₒₒₗ−\vec{F}_{gravity-F/T}−\vec{F}_{inertial-F/T)}
where \vec{F}_{graviy-tool} and \vec{F}ᵢₙₑᵣₜᵢₐₗ₋ₜₒₒₗ are the respective gravitational and inertial compensations for the tool, and
\vec{F}_{gravity-tool} and \vec{F}ᵢₙₑᵣₜᵢₐₗ₋ₜₒₒₗ are the respective gravitational and inertial compensations for the F/T sensor.

26. A robotic force/torque (F/T) sensor including transducers configured to generate signals in response to forces or torques applied to the sensor, comprising:
measurement circuitry configured to resolve force and torque measurements from the transducer signals, the force and torque measurements referenced to a body
Coordinate Frame (CF) of the F/T sensor; and
compensation circuitry configured to
obtain a mass m of the attached tool;
obtain an angular velocity \vec{ω} of the F/T sensor body CF;
obtain an angular acceleration \dot{ω} of the F/T sensor body CF;
obtain a linear acceleration \vec{α} of the F/T sensor body CF;
obtain the inertia tensor I defined in the F/T sensor body CF which contains all moments and products of inertia; and
compensate the force and torque measurements for inertial effects of movement of the robot based on m, \vec{ω}, \dot{ω}, \vec{r}_{CG}, \vec{α}, and I.

27. The F/T sensor of claim 26 wherein the compensation circuitry is configured to perform inertial compensation of force and torque measurements by continuously calculating
$${\vec{F}}_{contact} = {\vec{F}}_{measured} - {\vec{F}}_{inertial} ,$$
$$wherein$$
$${}^{6} {\vec{F}}_{inertial} = ( \begin{matrix}{\vec{F}}_{inertial} \\ {\vec{T}}_{inertial}\end{matrix} ) = ( \begin{matrix}m \vec{a} + m ( \dot{ω} \times {\vec{r}}_{CG} ) + m ( \vec{ω} \times ( \vec{ω} \times {\vec{r}}_{CG} ) ) \\ I \dot{ω} + \vec{ω} \times ( I \vec{ω} ) + m ( \dot{ω} \times {\vec{r}}_{CG} ) + m ( {\vec{r}}_{CG} \times \vec{a} )\end{matrix} ) .$$

28. The F/T sensor of claim 27 wherein the compensation circuitry is further configured to:
obtain the weight Wₜₒₒₗ of an attached tool;
obtain a vector \vec{r}_{CG} from the F/T sensor body CF origin to a center of gravity of the tool;
obtain a rotation matrix R_{Inertial CF}^{Body CF} from the F/T sensor body CF to an inertial reference frame; and
compensate the force and torque measurements for gravitational effects of the attached tool based on R_{Inertial CF}^{Body CF}, Wₜₒₒₗ, and \vec{r}_{CG}.

29. The F/T sensor of claim 28 wherein the compensation circuitry is configured to perform gravity and inertial compensation of force and torque measurements by continuously calculating
$${\vec{F}}_{contact} = {\vec{F}}_{measured} - {\vec{F}}_{gravity} - {\vec{F}}_{inertial} ,$$
$$wherein$$
$${\vec{F}}_{gravity} = ( \begin{matrix}{R}_{Inertial CF}^{Body CF} & {\vec{W}}_{tool} \\ S ( {\vec{r}}_{CG} ) {R}_{Inertial CF}^{Body CF} & {\vec{W}}_{tool}\end{matrix} ) ;$$
and S(•) denotes a skew-symmetric matrix operation.
